(19) United States
(12) Patent Application Publication
(10) Pub. No.: US 2020/0385174 A1
(43) Pub. Date: Dec. 10, 2020

(54) POUCH HANGER FOR A BUCKET

(71) Applicant: Danco, Inc., Irvine, TX (US)

(72) Inventors: Michael J. Schuster, Shorewood, IL (US); Thomas R. Bajek, Naperville, IL (US); Dwayne A. Porter, Lockport, IL (US)

(21) Appl. No.: 16/891,889

(22) Filed: Jun. 3, 2020

Related U.S. Application Data
(60) Provisional application No. 62/856,925, filed on Jun. 4, 2019.

(51) Int. Cl. B65D 33/14; E06C 7/14; B44D 3/14

(52) U.S. Cl. CPC B65D 33/14; B44D 3/14; E06C 7/14

(57) ABSTRACT

Disclosed are various embodiments of a pouch hanger that have be hanged from a utility bucket or other suitable support structures. One or more pouches can be suspended from the pouch hanger. The pouch hanger includes an arcuate member and an elevated hanger that extends from the arcuate member. A support tab extends from a recessed portion of the pouch hanger. The recessed portion extends from the elevated hanger. A top portion of the support tab is in a plane above the arcuate member. The elevated hanger forms a slot between the arcuate member and the recess portion adjacent to the support tab.

### CROSS-REFERENCE TO RELATED APPLICATIONS

This continuation application claims priority to and the benefit of U.S. Non-provisional Patent Application No. 62/856,925, entitled “POUCH HANGER FOR A BUCKET” and filed on Jun. 4, 2019, which is incorporated by reference as if set forth herein in its entirety.

### BACKGROUND

Utility buckets are commonly found at job sites, in garages, in warehouse facilities, and in many other areas. These buckets are used for a variety of purposes, such as for storing or transporting items. For example, a person may store paint or a variety of paint accessories in a utility bucket. In another situation, the person may store a variety of hand and drill tools, such as screw drivers, wrenches, power drill bits, socket adapters, screws, and other tools.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-1D illustrate various views of an exemplary pouch hanger for a utility bucket, according to one embodiment described herein.

FIGS. 2A-2D illustrate various views of an alternative exemplary pouch hanger for a utility bucket, according to one embodiment described herein.

FIGS. 3A-3E illustrates various views of a pouch that can be suspended from the pouch hanger of FIGS. 1A-1D or FIG. 2A-2D, according to one embodiment described herein.

FIGS. 4A-4G illustrates various views of a first configuration for hanging multiple pouch hangers from FIGS. 1A-1D on a utility bucket, according to one embodiment described herein.

FIGS. 5A-5G illustrates various views of a second configuration for hanging multiple pouch hangers from FIGS. 1A-1D on a utility bucket, according to one embodiment described herein.

FIGS. 6A and 6B illustrates a perspective view and a top view of multiple pouch hangers on a utility bucket, according to one embodiment described herein.

FIGS. 7A and 7B illustrates a perspective view of the pouch hanger from FIGS. 2A-2D and alternative pouch examples, according to one embodiment described herein.

FIG. 8 illustrates a perspective view of a pouch hanger from FIGS. 1A-1D suspended from a ladder, according to one embodiment described herein.

FIGS. 9A-9K illustrates various views of an alternative pouch hanger, according to one embodiment described herein.

### DETAILED DESCRIPTION

The present disclosure includes various examples related to a pouch hanger for a utility bucket. Utility buckets are commonly found at job sites, in garages, in warehouse facilities, and in many other areas. These buckets are used for a variety of purposes, such as for storing or transporting items. For example, a five gallon bucket may be used to store paint supplies, power drill accessories, or other tools. In some scenarios, a person may desire to organize tools, accessories, and other items for different type of tasks.

The embodiments of the present disclosure relate to a pouch hanger that is configured to hang one or more pouches from a side of a utility bucket. The pouch hanger allows for the one or more pouches to be hung from an interior or exterior of the utility bucket. The pouches can be used to store and transport various tools or items. Further, the various embodiments of the pouch hanger enable the interior area of a utility bucket to store content (e.g., liquids) without the content coming into contact with items stored in the pouch. In the context of the present disclosure, a pouch can refer to a flexible or rigid bag or container for storing various items or materials.

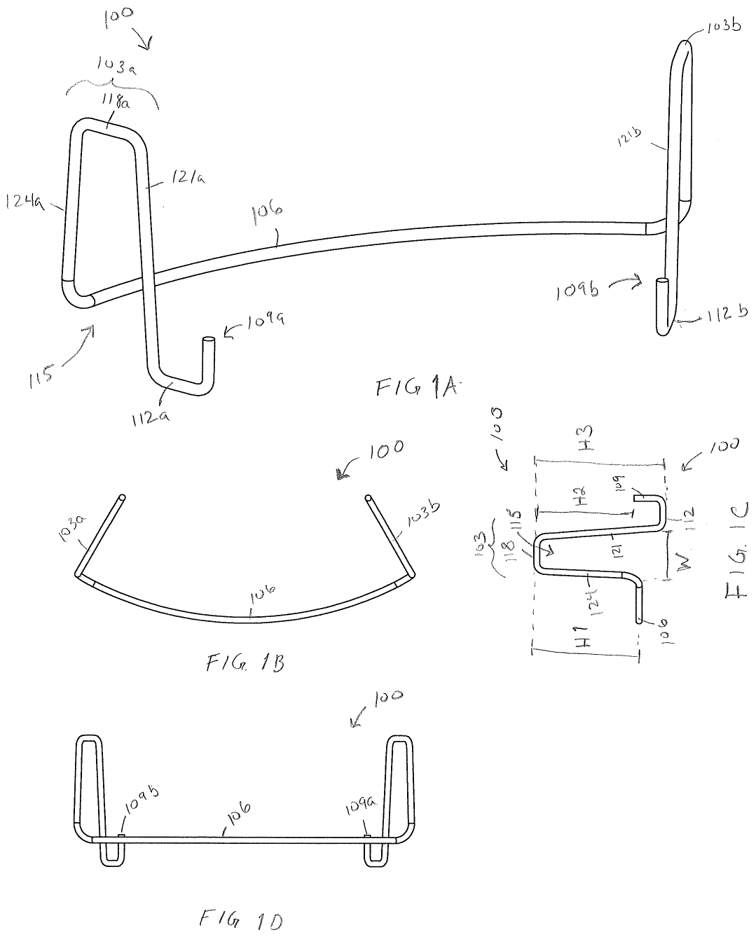

Beginning with FIGS. 1A-1D, shown are various views of an exemplary pouch hanger 100 for a utility bucket. FIG. 1A illustrates a front perspective view of the pouch hanger 100. FIG. 1B illustrates a top view of the pouch hanger 100, and FIG. 1C illustrates a side view of the pouch hanger 100. FIG. 1D illustrates a back view of the pouch hanger 100.

The pouch hanger 100 can be used to suspend one or more pouches from an interior and/or exterior of a utility bucket. A utility bucket can represent a pail or a container for storing items or liquids. The bucket can have a circular shape, a rectangular shape, or other suitable shapes. For example, a circular five gallon bucket is commonly used for construction jobs. In this non-limiting example, the five gallon bucket can have a height in a range between 14-16 inches, a diameter in a range between 12-14 inches, and a thickness in a range of 0.25 millimeters to 9 millimeters. The pouch hanger 100 can be configured to be suspended from the standard five gallon bucket or buckets of other dimensions.

The pouch hanger 100 can include a first elevated hanger 103a, a second elevated hanger 103b, an arcuate member 106, a first support tab 109a, and a second support tab 109b. The pouch hanger 100 can be made as a single piece structure or can be comprised of multiple assembled components. The pouch hanger 100 can be made from steel, brass, aluminum, iron, chrome aluminum, or other suitable metallic materials. The pouch hanger 100 can also be comprised of various types of plastic materials. In some embodiments, the pouch hanger 100 can comprise a first metallic material as a first material and also have a second material as a coating over the first material. For example, a rubber, plastic, latex, or silicone coating may be distributed over a metallic material.

The arcuate member 106 of the pouch hanger 100 can extend from a first end to a second end. The arcuate member 106 can extend from the first elevated hanger 103 on the first end to the second elevated hanger 103 on the second end. The first elevated hanger 103a and the second elevated hanger 103b (collectively “elevated hangers 103”) can extend radially inward from the arcuate member 106. The elevated hangers 103 can extend from the recessed portions 112, 112b, which in turn extend from support tabs 109a, 109b.

The arcuate member 106 can be a portion of the pouch hanger 100 that is used to brace the pouch hanger 100 against various areas of the utility bucket. The arcuate member 106 can be placed in different positions along the sides of a utility bucket. The arc of the arcuate member 106 can correspond to a curvature of a perimeter of a utility bucket. The arcuate member 106 can extend from the first elevated hanger 103a to the second elevated hanger 103b.

The elevated hangers 103 can be used to hang the pouch hanger 100 from a rim of a utility bucket. The elevated hangers 103 form a slot 115 for receiving the rim of the utility bucket. In the illustrated non-liming example, the slot 115 is formed between the arcuate member 106 and the recessed portions 112a, 112b. The elevated hangers 103 can include a rim support member 118, a front support member 121, and a back support member 124. In the illustrated embodiment, these components of the elevated hangers 103 are used to form the slot 115. Since the slot 115 is formed between the first elevated hanger 103a and the second elevated hanger 103b, the slot 115 can have a curve that corresponds to a perimeter of a rim of the utility bucket.

When the pouch hanger 100 is positioned on the utility bucket, the rim support member 118 can contact a top surface of the rim of the utility bucket. Portions of the front support member 121 and the back support member 124 can come into contact with either aspects of the interior and/or exterior sides of the utility bucket.

In the illustrated embodiment, the front support member 121a extends from the recessed portions 112a. The front support members 121 elevate the rim support members 118 in a plane above the arcuate member 106 and the recessed portion 112a. The back support members 124 extend from the arcuate member 106 and elevate the rim support member 118a in a plane above the arcuate member 106 and the recessed portion 112a.

The first recessed portion 112a and the second recessed portion 112b (collectively the “recessed portions 112”) extend from the front support member 121. Each of the recessed portions 112 extend also from either the first support tab 109a or the second support tab 109b (collectively the “support tabs 109”). The support tabs 109 can be used to hang one or more pouches from the pouch hanger 100. The support tabs 109 can be inserted through an opening of a pouch. The pouch can be positioned on the recessed portions 112. A top portion of the support tabs 109 extend to a plane above the recessed portions 112, which allows the support tabs 119 to help retain the pouch within the recessed portions 112.

FIG. 1B illustrates a top view of the pouch hanger 100 from FIG. 1A. As shown in FIG. 1B, the first elevated hanger 103a and the second elevated hanger 103b extend radially inward from the arcuate member 106 toward a center point of intersection for the elevated hangers 103.

Moving on to FIG. 1C, shown is a side view of the pouch hanger 100 from FIG. 1A. FIG. 1C illustrates a first height “H1” from the arcuate member 106 to the rim support member 118, and FIG. 1C also illustrates a second height “H2” from a top portion of the support tab 109 to the rim support member 118. A third height “H3” is also depicted, which extends from the recessed portion 112 to the rim support member 118. In the illustrated embodiment, the first height “H1” is larger than the second height “H2.” The third height “H3” is also larger than the first height “H1” and the second height “H2.” The slot 115 also has a width “W” at the elevated hanger 103 that is configured to receive a rim of the utility bucket. As shown in FIG. 1C, the width “W” can be represented as a distance between the back support member 124 and the front support member 121. In some embodiments, the width “W” of the slot 115 can be in a range between 0.02 inches to 1.5 inches. A typical five-gallon bucket may have a wall thickness about 0.075 inches. FIG. 1D illustrates a back view of the pouch hanger 100. As illustrated in FIG. 1D, the support tabs 109 extend to a plane above the arcuate member 106.

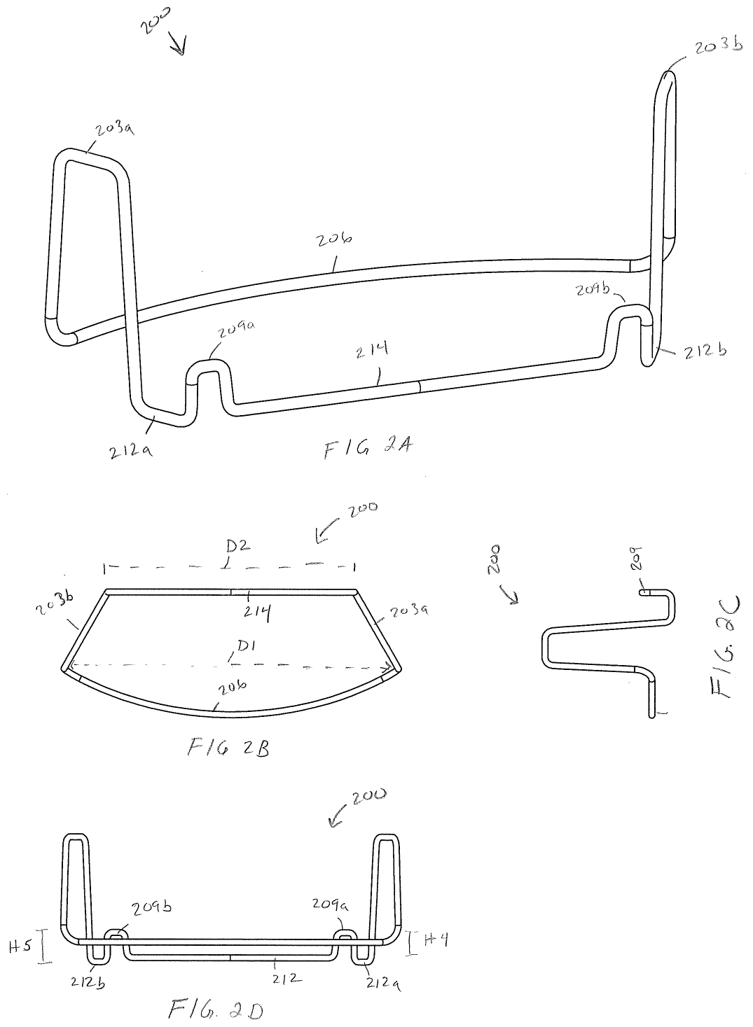

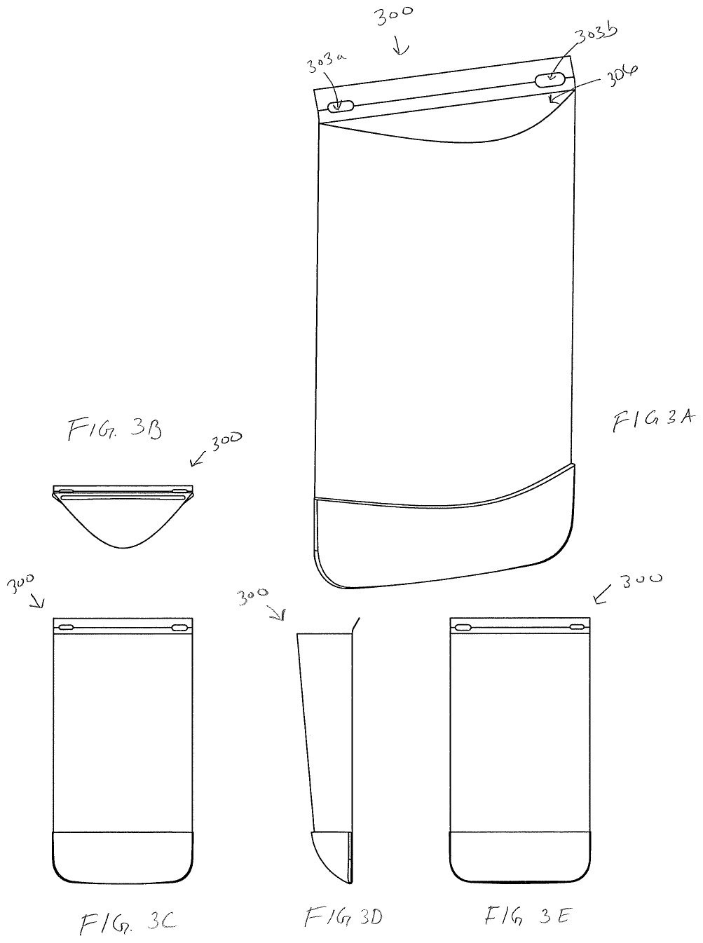

With reference to FIGS. 2A-2D, shown are various views of an alternative example of a pouch hanger 200. The pouch hanger 200 includes many similar components as the pouch hanger 100 from FIGS. 1A-1D. FIG. 2A illustrates a front perspective view of the pouch hanger 200. The pouch hanger 200 includes a first elevated hanger 203a, a second elevated hanger 203b, an arcuate member 206, a first support tab 209a, a second support tab 209b, a first recessed portion 212a, a second recessed portion 212b, and a recessed lateral member 214.

The arcuate member 206 can extend from the first elevated hanger 203a to the second elevated hanger 203b. The first elevated hanger 203a and the second elevated hanger 203b (collectively the “elevated hangers 203”) can also extend from the first recessed portion 212a and the second recessed portion 212b respectively (collectively the “recessed portions 212”). The first support tab 209 and the second support tab 209 (collectively the “support tabs 209”) can extend from the recessed portions 212. The recessed lateral member 214 can extend between the first support tab 209a and the second support tab 209b.

In some embodiments, the recessed lateral member 214 can be in a different plane from the recessed portions 212. Thus, from some views, the recessed lateral member 214 may be elevated to a height above the position of the recessed portions 212.

FIG. 2B illustrates a top view of the pouch hanger 200 from FIG. 2A. FIG. 2B depicts a first lateral distance “D1” between a first end and a second end of the arcuate member 206. A second lateral distance “D2” can represent a distance between the first support tab 209b and the second support tab 209, in which the recessed lateral member 214 is in between the support tabs 209. As shown in FIG. 2B, the second lateral distance “D2” is larger than the first lateral distance “D1.”

FIG. 2C illustrates a side view of the pouch hanger 200 from FIG. 2A. FIG. 2D illustrates a back view of the pouch hanger 200 from FIG. 2A. FIG. 2D depicts a height “H4” from the recessed lateral member 214 to a top portion of the support tabs 209, and also depicts a height “H5” from the recessed portions 212 to the top portion of the support tabs 209. In this embodiment, height “H5” is greater than height “H4,” which indicates that the recessed lateral member 214 is elevated in a plane close to the top of the support tabs 209.

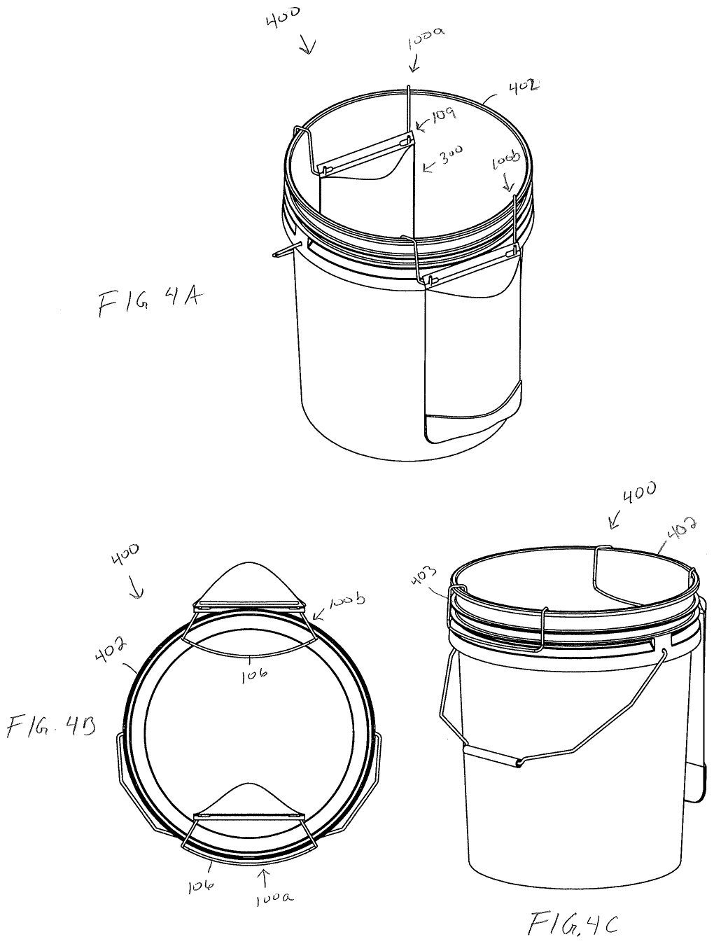

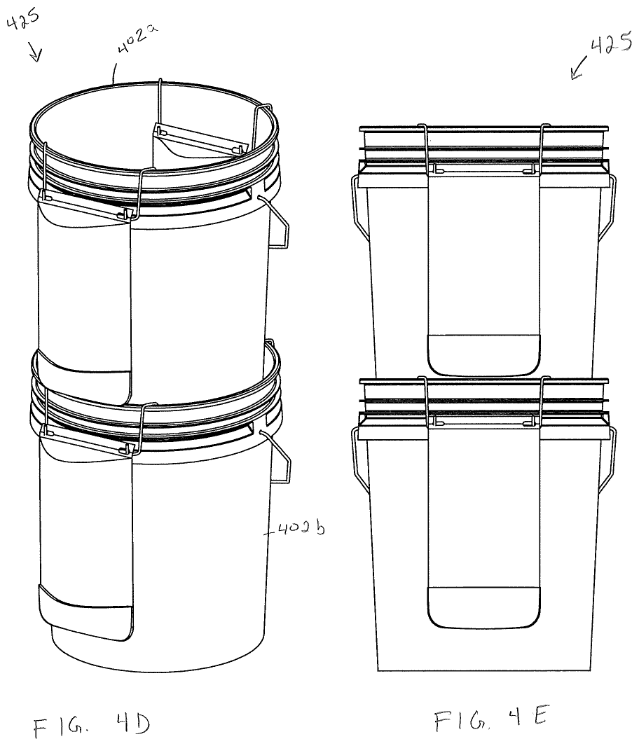

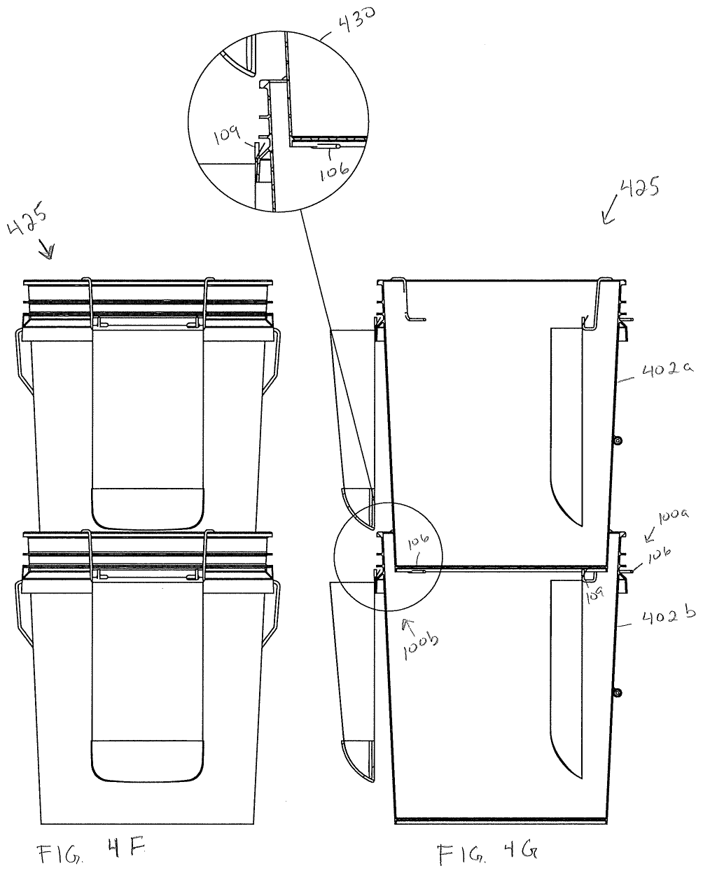

With reference to FIGS. 3A-3E, shown are various views of a pouch 300 that can be suspended from the pouch hangers 100, 200 of the present disclosure. FIG. 3A illustrates a front perspective view of the pouch 300 and FIG. 3B illustrates a top view of the pouch 300. FIG. 3C illustrates a front view of the pouch 300. FIG. 3D illustrates a side view of the pouch 300 and FIG. 3E illustrates a front view of the pouch 300. In the illustrated example, the pouch 300 includes a first aperture 303a and a second aperture 303b (collectively the “apertures 303”). The support tabs 109, 209 (FIGS. 1A-1D and FIGS. 2A-2D) can be inserted through the apertures 303, which enables the pouch 300 to be hanged from pouch hanger 100, 200 (FIGS. 1A-1D and FIGS. 2A-2D). The pouch 300 also includes an opening 306 that provides access to an interior of the pouch 300. Within the interior, the pouch 300 can store various items, such as tools, drill bits, nails, screws, nuts, washers, fittings tape, paint brushes, paint accessories, and other tools, components or accessories items.

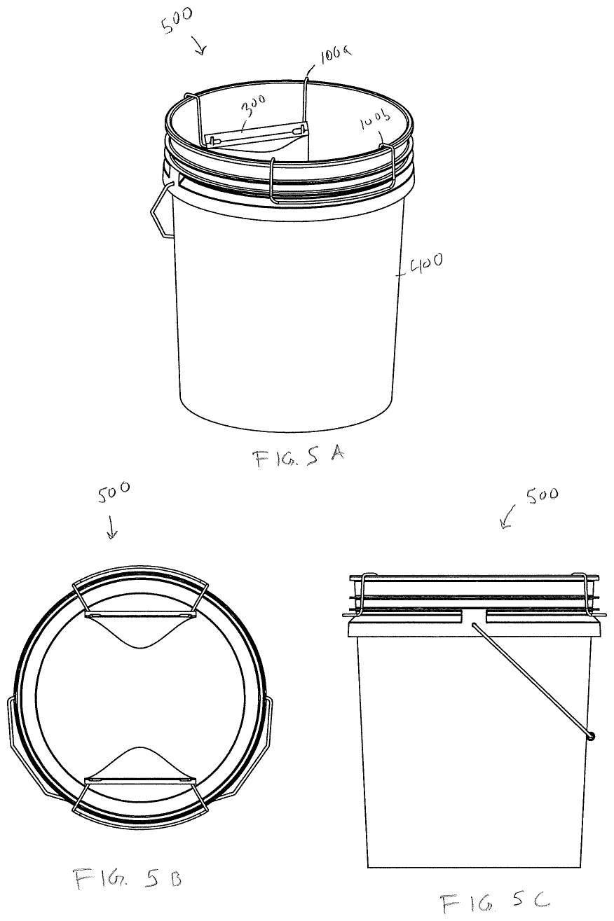

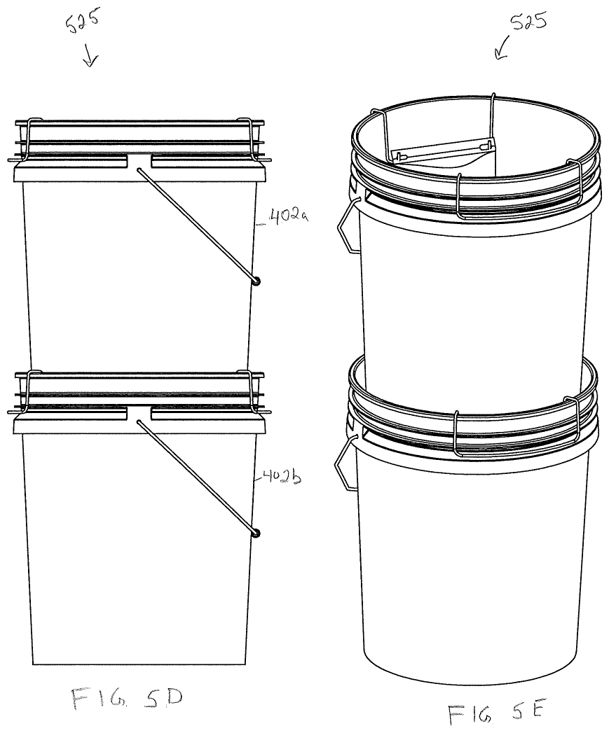

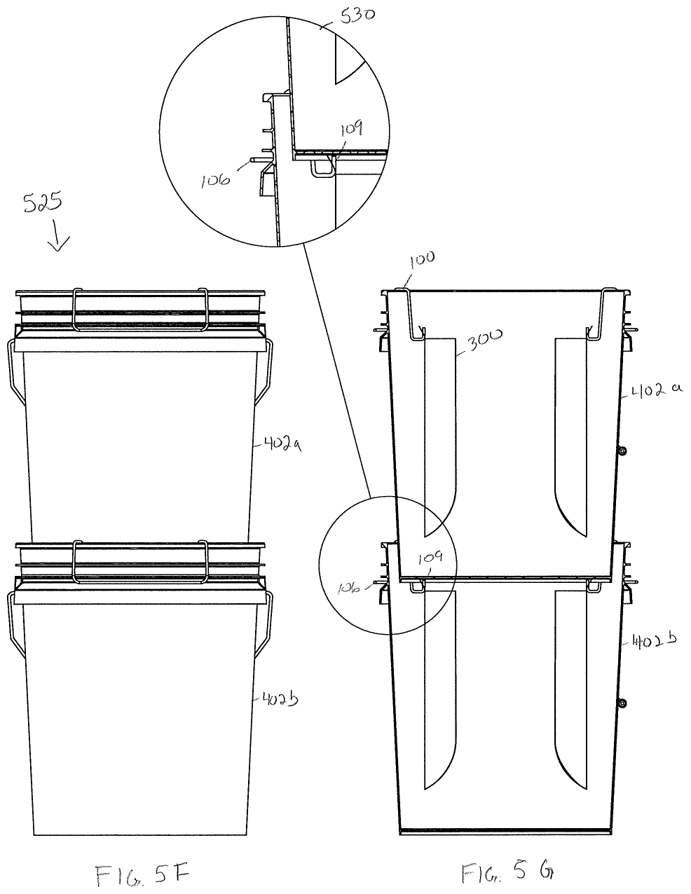

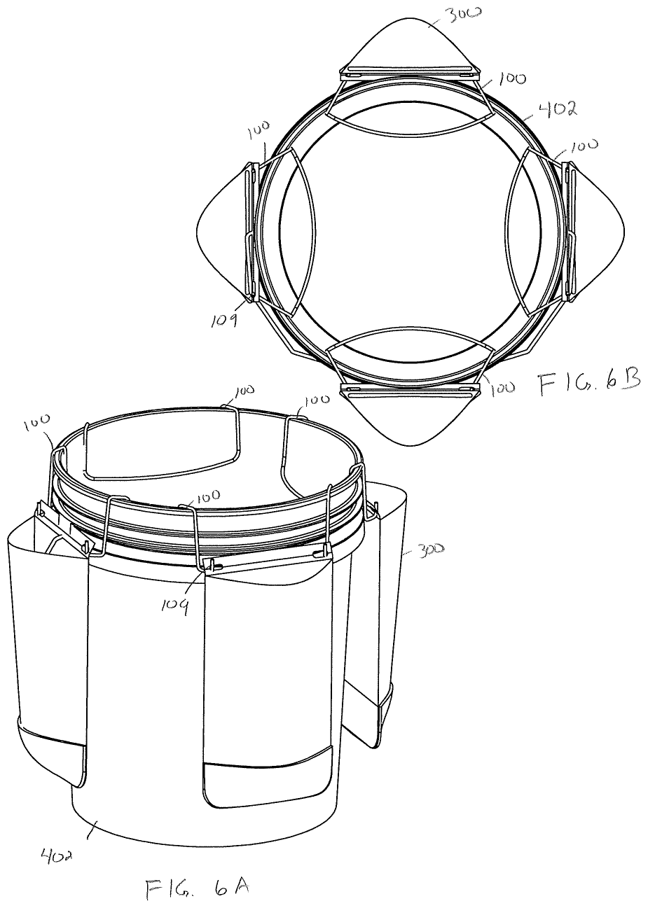

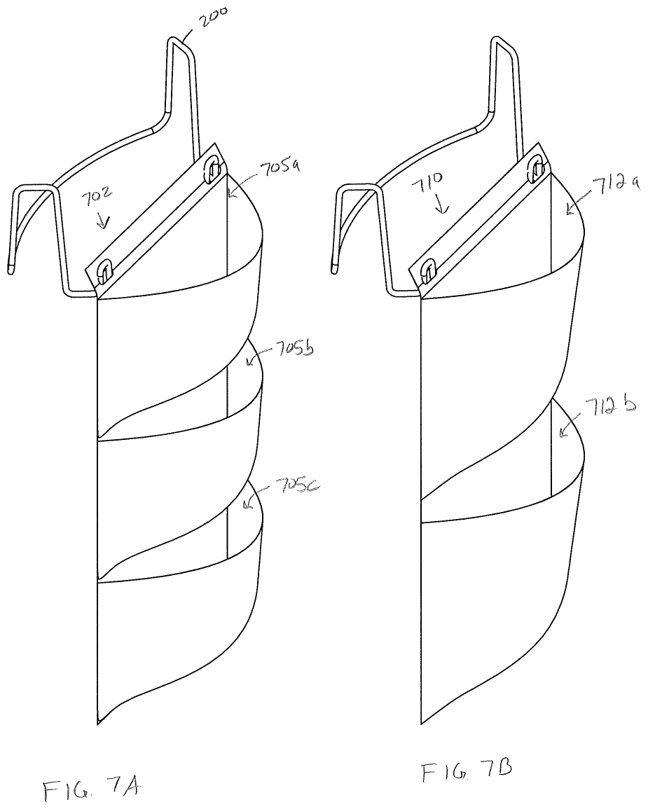

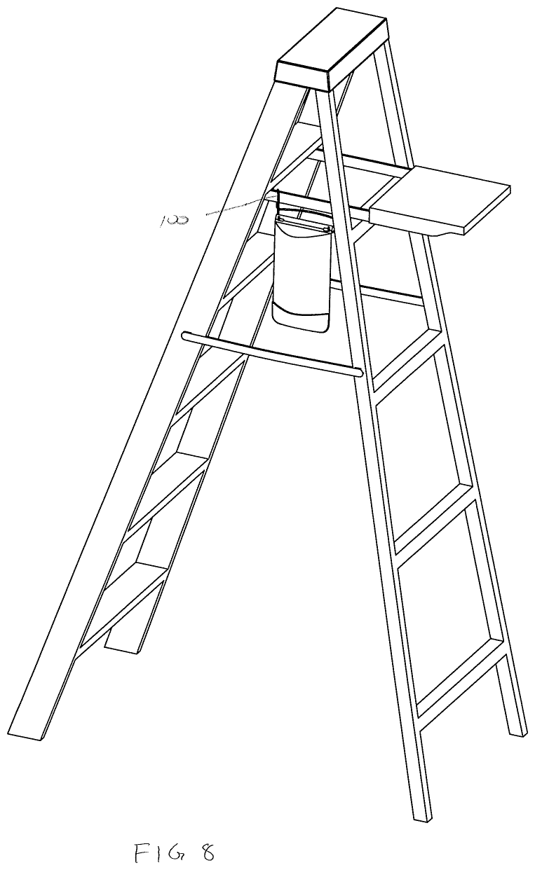

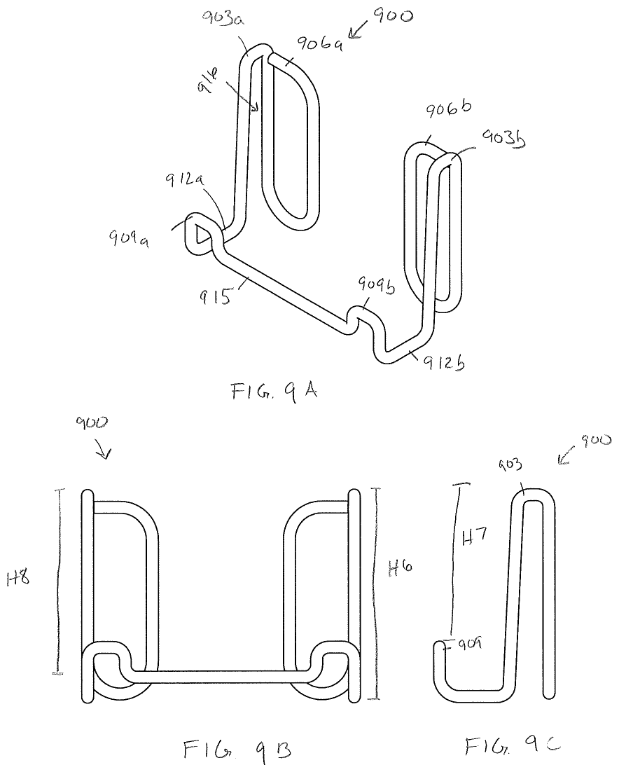

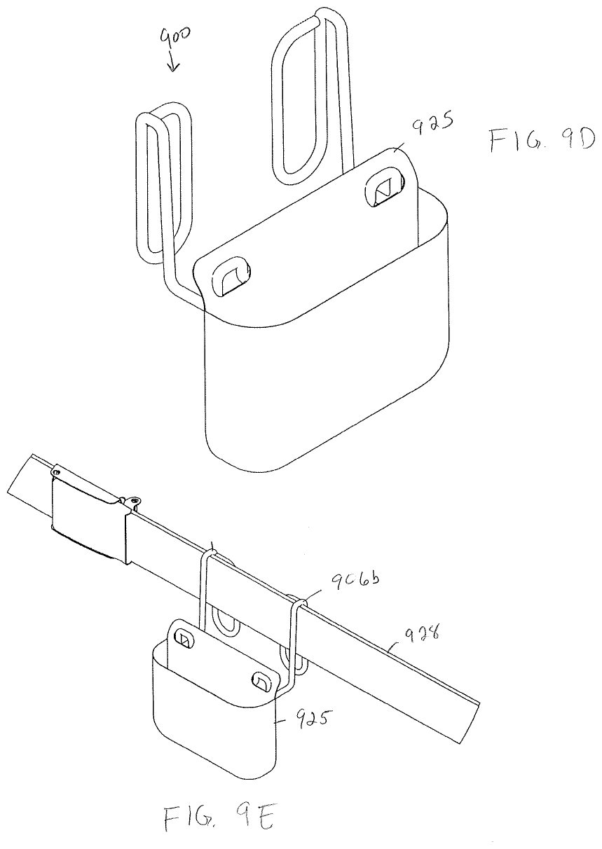

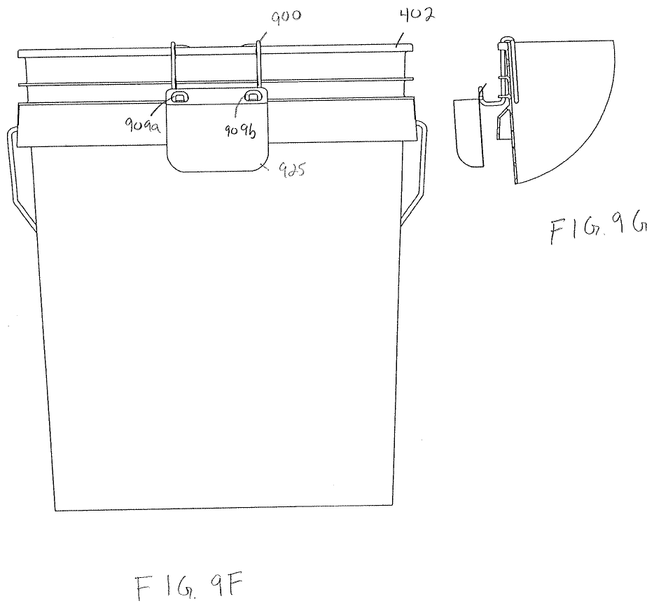

Moving on to FIGS. 4A-4G, shown are various views of the multiple pouch hangers 100 and multiple pouches 300 positioned on a utility bucket 402 in a first configuration 400. The pouch hangers 100 can be positioned on a utility bucket 402 in various configurations for hanging pouches 300. FIG. 4A illustrates an upper perspective view of the first configuration 400 of a first pouch hanger 100a oriented with its support tabs 109 within the interior of the utility bucket 402, and a second pouch hanger 100b oriented with its support tabs 109 outside the utility bucket 402.

In this first configuration 400, the support tabs 109 of the first pouch hanger 100a and the arcuate member 106 of the second pouch hanger 100b can be used to support another utility bucket 402. Thus, the first configuration 400 is one exemplary configuration, among several, for stacking or nesting multiple utility buckets 402 while hanging pouches 300 for item storage. For example, another configuration can include two or more pouch hangers 100 with the support tabs 109 on the exterior of a utility bucket 402. Allowing buckets to be stacked without buckets sticking together.

FIG. 4B depicts a top view of the first configuration 400 of the multiple pouch hangers 100 and multiple pouches 300. In FIG. 4B, the first pouch hanger 100a has the arcuate member 106 positioned on the exterior of the utility bucket 402. In this position, the arcuate member 106 is used to brace against an exterior side or other exterior components (e.g., lips) of the utility bucket 402.

The second pouch hanger 100b has its arcuate member 106 positioned within the interior of the utility bucket 402. The arcuate member 106 is braced against the interior surface of the utility bucket 402 in this position, as a non-limiting example. FIG. 4C illustrates a lower perspective view of the first configuration of the multiple pouch hangers 100 and pouches 300. As shown in FIG. 4C, a utility bucket 402 can have one or more lips 403 on the exterior surface. In some cases, the arcuate member 106 can be braced underneath one of the lips 403 of the utility bucket 402.

Moving on to FIG. 4D, shown is a front perspective view of a first nested arrangement 425 of the multiple utility buckets 402 in the first configuration 400 (FIGS. 4A-4C). In the first nested arrangement 425, a portion of the first utility bucket 402a is nested within the interior of the second utility bucket 402b. As depicted in the first nested arrangement 425 in FIG. 4D, an operator has access to the openings 306 (FIGS. 3A-3E) of multiple pouches 300 (FIGS. 3A-3E) while the first utility bucket 402a is nested within the second utility bucket 402b. Accordingly, the first nested arrangement 425, and other arrangements as will be described, provide an operator access to multiple pouches 300 while nesting multiple utility buckets 402.

As a non-limiting example, a do-it-yourself individual may have multiple projects that involve using different tools. For instance, the individual may have an electrical project, a plumbing project, and a carpentry project. A first bucket 402 can store tools and accessories for the electrical project in a first pouch 300 hung from a first pouch hanger 100, and a second bucket 402 can store tools and accessories for the plumbing project in second pouch 300 hung from a second pouch hanger 100. A third bucket 402 can store tools and accessories for the carpentry project in a third pouch 300 hung from a third pouch hanger 100. The tools and accessories for each project can be organized separately by using three pouch hangers 100. Further, the buckets 402 can be nested within each other using the pouch hangers 100 as shown in FIGS. 4D-4G and 5D-5G.

As another non-limiting example, a painter may store a first color of paint in the first utility bucket 402a and a second color of paint in the second utility bucket 402b. The painter can store a first set of paint brushes and other accessories in the pouches 300 of the pouch hangers 100 hanging on the first utility bucket 402a. The painter could also store a second set of paint brushes and other accessories in the pouches 300 of the pouch hangers 100 hanging on the second utility bucket 402b. Accordingly, the pouch hangers 100 enable for multiple utility buckets 402 to be nested and provide storage for items without interacting with the interior contents (e.g., paint) of the utility buckets 402. FIGS. 4E and 4F illustrate side views of the first nested arrangement 425 from FIG. 4D.

FIG. 4G depicts a cross-sectional view of the first nested arrangement 425 of multiple utility buckets 402, as illustrated in FIGS. 4D-4F. FIG. 4G also includes an enlarged view 430 of an engagement between the arcuate member 106 of the second pouch hanger 100b and a bottom of the first utility bucket 402a. FIG. 4G also illustrates the engagement between the support tabs 109 of the first pouch hanger 100a and the bottom of the first utility bucket 402a. In this non-limiting example, it should be noted that the support tabs 109 have a different engagement point with the bottom of the utility bucket 402a than the arcuate member 106. The utility buckets 402 have a perimeter rim that elevates the bottom surface of the utility buckets 402. As illustrated in the enlarged view 430, the arcuate member 106 engages with the perimeter rim of the bottom of the utility bucket 402. While FIG. 4G illustrates that the support tabs 109 engage with the bottom surface of the utility bucket 402a. In this non-limiting example, these different engagement points enable for the first utility bucket 402a to be supported in a level plane.

Moving on to FIGS. 5A-5G, shown are various views of the multiple pouch hangers 100 and multiple pouches 300 positioned on a utility bucket 402 in a second configuration 500. The pouch hangers 100 can be positioned on a utility bucket 402 in various configurations for hanging pouches 300. FIG. 5A illustrates an upper perspective view of the second configuration 500 of a first pouch hanger 100a and a second pouch hanger 100b oriented with their support tabs 109 within the interior of the utility bucket 402.

In this second configuration 500, the supports tabs 109 of the first pouch hanger 100a and the second pouch hanger 100b can be used to support the bottom surface of another utility bucket 402. Thus, the second configuration 500 is another exemplary configuration, among several, for stacking and/or nesting multiple utility buckets 402 while hanging pouches 300 for item storage.

FIG. 5B depicts a top view of the second configuration 500 of the multiple pouch hangers 100 and multiple pouches 300. In FIG. 5B, the first pouch hanger 100a and the second pouch hanger 100b have their arcuate members 106 positioned on the exterior of the utility bucket 402. The arcuate members 106 are used in this example to brace against the exterior of the utility bucket 402 in this position, as a non-limiting example. FIG. 5C illustrates a side view of the second configuration 500 of the multiple pouch hangers 100 and pouches 300.

Moving on to FIG. 5D, shown is a side view of a second nested arrangement 525 of multiple utility buckets 402 in the second configuration 500 (FIGS. 5A-5C). FIG. 5E illustrates a perspective view of and FIG. 5F illustrates a side view of the second nested arrangement 525 of the multiple utility buckets 402. In the second nested arrangement 525, a portion of the first utility bucket 402a is nested within the interior of the second utility bucket 402b. As depicted in the second nested arrangement 525 in FIG. 5D, an operator has access to the openings 306 (FIGS. 3A-3E) of multiple pouches 300 (FIGS. 3A-3E) for the first utility bucket 402a. The pouches 300 for the second utility bucket 402b are not accessible while in the second nested arrangement.

FIG. 5G depicts a cross-sectional view of the second nested arrangement 525 of multiple utility buckets 402, as illustrated in FIGS. 5D-4F. FIG. 4G also includes an enlarged view 530 of an engagement between the support tabs 109 of the pouch hangers 100 and the bottom of the first utility bucket 402a. In this non-limiting example, it should be noted that the support tabs 109 engage with the bottom surface of the utility bucket 402a. The bottom surface is elevated by a rim perimeter at the bottom of the utility bucket 402.

Next, FIGS. 6A and 6B illustrate a perspective view and a top view of four pouch hangers 100 suspended from the rim of a utility bucket 402. As illustrated, the four pouch hangers 100 are located at different positions along the rim of the utility bucket 402. The pouch hangers 100 are oriented with the support tabs 109 positioned along the exterior of the utility bucket 402.

Moving on to FIG. 7A, shown is a perspective view of pouch hanger 200 from FIGS. 2A-2D and a pouch 702. In this non-limiting example, the pouch 702 includes a first opening 705a, a second opening 705b, and third opening 705c for storage of items. FIG. 7B illustrates a perspective view of pouch hanger 200 and a pouch 710 that includes two openings 712a, 712b. Although two openings 712 and three openings 705 are shown in FIG. 7A and FIG. 7B respectively, the number of openings 712 for a pouch 702, 710 can vary.

FIG. 8 illustrates a perspective view of the pouch hanger 100 from FIGS. 1A-1D suspended from a ladder. The pouch hanger 100 is suspend from a spreader of the ladder, in which the spreader is positioned within the slot 115 (FIG. 1A) of the pouch hanger 100.

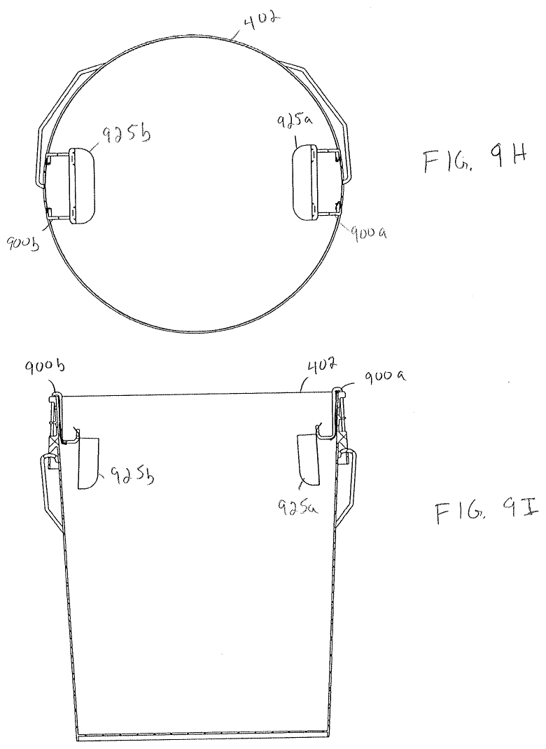

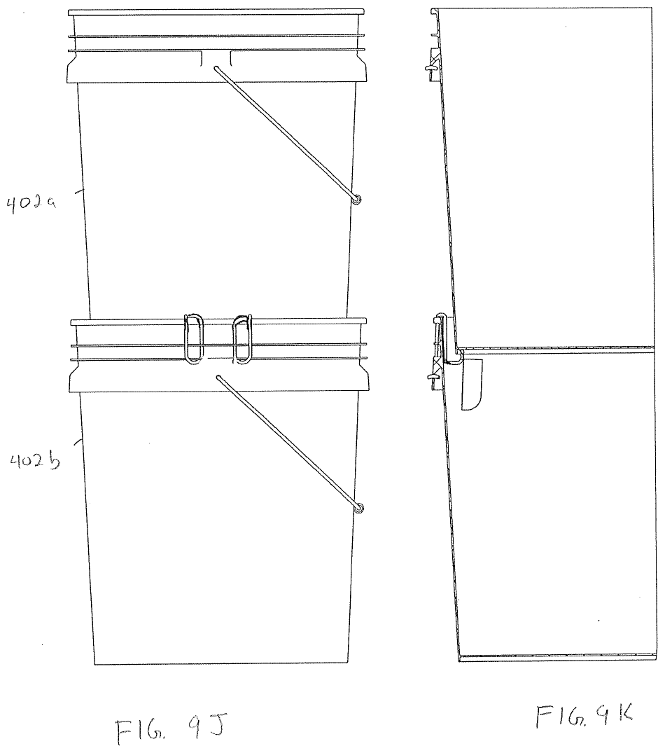

Next, FIGS. 9A-9C illustrates various views of an alternative pouch hanger 900 configured to be hung from a belt, a belt clip, a pair of pants of an operator, or other suitable means of attachment to an operator. In other scenarios, the alternative pouch hanger 900 can be suspended from a ladder, a utility bucket, or some other suitable lateral support structure. FIG. 9A illustrates a front perspective view of the alternative pouch hanger 900, and FIG. 9B illustrates a front view of the alternative pouch hanger 900. FIG. 9C illustrates a side view of the alternative pouch hanger 900. In this non-limiting example, the alternative pouch hanger 900 includes a first hanger 903a, a second hanger 903b (collectively the “hangers 903”), a first support member 906a, a second support member 906b (collectively the “support members 906”), a first support tab 909a, a second support tab 909b (collectively the “support tabs 906”), a first recessed portion 912a, a second recessed portion 912b (collectively the “recessed portions 912”), and a recessed lateral member 915.

The support members 906 can be used to provide support against an object or structure when the alternative pouch hanger 900 is suspended. For example, when positioned on a belt of an operator, the alternative pouch hanger 900 can be braced against the belt (FIG. 9E) or pair of pants by at least the support members 906. In the illustrated non-limiting example, the support members 906 have an oblong shape. It should be noted that the support members 906 can be formed in a rectangular shape, a circular shape, a triangular shape, or other shapes and support structures.

The hangers 903 extend substantially perpendicular from the support members 906. It should be noted that the hangers 903 can be oriented at different angles from the support members 906. The hangers 903 form a slot 916 for receiving a belt or some other support structure for which the alternative pouch hanger 900 can be suspended. The slot 916 can be formed from the first hanger 903a and the first support member 906a and from the second hanger 903b and the second support member 906b. In this non-limiting example, the slot 916 is lateral, which facilitates being hung from a lateral support structure.

The recessed portions 912 extend from the hangers 903. The recessed portions 912 provide an area for which a pouch or bag can be positioned and retained on the alternative pouch hanger 900. As shown in FIG. 9B, a height “H6” represents a distance between the recessed portions 912 and the top of the hangers 903.

The support tabs 909 extend from the recessed portions 912. An opening of a pouch can be inserted through one of the support tabs 909. The support tabs 909 can be used to retain the pouch that is positioned along the recessed portions 912. As shown in FIG. 9C, a height “H7” represents a distance between the top of the support tabs 909 to the top of the hangers 903.

The recessed lateral member 915 can extend between two support tabs 909. As shown in FIG. 9B, a height “H8” represents a distance between the recessed lateral member 915 and the top of the hangers 903. In this non-limiting example, height “H8” is less than height “H6.” Height “H7” is less than height “H8” and height “H6.”

FIG. 9D illustrates a perspective view of the alternative pouch hanger 900 and a pouch 925. FIG. 9E illustrates a perspective view of the alternative pouch hanger 900 hanging from a belt 928 that can be worn by an operator. As shown, the belt 928 is positioned in the slot 916 (FIG. 9A) of the alternative pouch hanger 900.

Moving on to FIGS. 9F-9K, shown are various views of the pouch 925 hanging from the alternative the pouch hanger 900, which is in turn hanging from a rim of a utility bucket 402. FIG. 9F illustrates a side view of the alternative pouch hanger 900 suspended from the rim of the utility bucket 402, in which the support tabs 909 are positioned outside of the utility bucket 402. As depicted in FIGS. 9E and 9F, the alternative pouch hanger 900 can be hanged from various items or support structures. In some examples, the recessed lateral member 915 can bend to form an arc, which enables the support members 906 to substantially flatten out against the exterior side of the utility bucket 402.

FIG. 9G illustrates an enlarged view of a portion of a cross-sectional view of FIG. 9F. FIG. 9H illustrates a top view of a first pouch hanger 900a and a second pouch hanger 900b (collectively the “pouch hangers 900”) hanging from a utility bucket 402. The pouch hangers 900 are depicted with their support tabs 909 (FIG. 9A) positioned within the interior of the utility bucket 402. Pouches 925 are shown hanging from the pouch hanger 900. FIG. 9I illustrates a cross-sectional view of the configuration of the pouch hangers 900 shown in FIG. 9H. FIG. 9J illustrates a side view of a first utility bucket 402a nested within a portion of a second utility bucket 402b. The first utility bucket 402a is placed on the support tabs 909 of the pouch hangers 900 in FIGS. 9H and 9I. FIG. 9K illustrates a cross-sectional view of the nested arrangement illustrated in FIG. 9J.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A pouch hanger for a bag, comprising:
an arcuate portion that extends from a first end to a second end;
a first elevated hanger that extends from the first end of the arcuate portion;
a second elevated hanger that extends from the second end of the arcuate portion; and
a first support tab that extends from the first elevated hanger and a second support tab that extends from the second elevated hanger.

2. The pouch hanger of claim 1, wherein a first recessed portion extends from the first elevated hanger to the first support tab, and a second recessed portion extends from the second elevated hanger to the second support tab.

3. The pouch hanger of claim 2, wherein the first recessed portion and the second recessed portion are in a plane below the arcuate portion.

4. The pouch hanger of claim 2, further comprising a lateral recessed member between the first support tab and the second support tab, the lateral recessed member being in a plane above at least one of the first recessed portions or the second recessed portion.

5. The pouch hanger of claim 1, wherein an elevated portion of at least one of the first support tab or the second support tab is in a plane above the arcuate portion.

6. The pouch hanger of claim 1, wherein at least one of the first elevated hanger and the second elevated hanger form a slot between a first support member that extends from the arcuate portion and a second support member that extends from a recessed portion.

7. The pouch hanger of claim 1, wherein at least one of the first elevated hanger and the second elevated hanger extends radially from the arcuate portion toward a center point.

8. An apparatus for retaining a tool bag, comprising:
an arcuate member;
an elevated hanger that extends from the arcuate member; and
a support tab that extends from a recessed portion, wherein the recessed portion extends from the elevated hanger, wherein a top portion of the support tab is in a plane above the arcuate member; and
wherein the elevated hanger forms a slot between the arcuate member and the recess portion adjacent to the support tab.

9. The apparatus of claim 8, wherein the support tab comprises a first support tab, and further comprising a second support tab that is connected to the first support tab by a recessed lateral member.

10. The apparatus of claim 9, wherein the recessed lateral member is in a plane above the recessed portion.

11. The apparatus of claim 10, wherein the arcuate member is in a plane above the recessed lateral member and the recessed portion.

12. The apparatus of claim 9, wherein the elevated hanger comprises a first elevated hanger, and the arcuate member extends from the first elevated hanger to a second elevated hanger.

13. The apparatus of claim 12, wherein a first distance between a first end and a second end of the recessed lateral member is less than a second distance between a third end and a fourth end of the arcuate member.

14. The apparatus of claim 8, wherein the elevated hanger extends radially from the arcuate member toward the recessed portion.

15. A method for placing a pouch hanger on a bucket, comprising:
providing a pouch hanger that comprises an arcuate portion extends from a first elevated hanger to a second elevated hanger, the pouch hanger comprising a lateral portion that extends from the first elevated hanger to the second elevated hanger, the first elevated hanger and the second elevated hanger forming a slot between the arcuate portion and the lateral portion, the lateral portion comprising a support tab;
positioning an opening of the slot of the pouch hanger adjacent to a rim of a bucket; and
inserting the rim of the bucket into the slot of the pouch hanger.

16. The method of claim 15, wherein the pouch hanger comprises a first pouch hanger, the slot comprising a first slot, and further comprising:
inserting the rim of the bucket into a second slot of a second pouch hanger.

17. The method of claim 16, wherein the bucket comprises a first bucket, the arcuate portion comprises a first arcuate portion, and further comprising:
positioning a bottom rim of a second bucket on the first arcuate portion of the first pouch hanger and on a second arcuate portion of the second pouch hanger.

18. The method of claim 16, wherein the bucket comprises a first bucket, the lateral portion comprises a first lateral portion, and further comprising:
positioning a bottom rim of the first lateral portion of the first pouch hanger and on a second lateral portion of the second pouch hanger.

19. The method of claim 16, wherein the bucket comprises a first bucket, the lateral portion comprises a first lateral portion, and further comprising:
positioning a bottom rim of the arcuate portion of the first pouch hanger and on a second lateral portion of the second pouch hanger.

20. The method of claim 16, further comprising inserting the support tab through an opening of a pouch.
